(19) United States
(12) Patent Application Publication
(10) Pub. No.: US 2010/0112437 A1
(43) Pub. Date: May 6, 2010

(54) LITHIUM ION SECONDARY BATTERY

(75) Inventors: Masanori Yoshikawa, Hitachinaka (JP); Yoshimi Yanai, Kitaibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/609,118

(22) Filed: Oct. 30, 2009

(30) Foreign Application Priority Data
Oct. 30, 2008 (JP) 2008-279039

(51) Int. Cl. H01M 10/26

(52) U.S. Cl. 429/207

(57) ABSTRACT

The present invention provides a lithium ion secondary battery that has high degrees of reliability and safety and is applicable to an auxiliary electric power supply for a next-generation clean energy vehicle such as a fuel-cell-powered vehicle, a plug-in hybrid electric vehicle or the like.

A lithium ion secondary battery in the present invention comprises a positive electrode capable of lithium storage and release; a negative electrode capable of lithium storage and release; a nonaqueous electrolytic solution containing a lithium salt; and a separator interposed between the positive electrode and the negative electrode, wherein the separator is a porous polymer membrane, and a layer including lithium carbonate and a separator binder is formed on a surface of the separator facing the positive electrode.

### CLAIM OF PRIORITY

The present application claims priority from Japanese patent application serial No. 2008-279039, filed on Oct. 30, 2008, the content of which is hereby incorporated by reference into this application.

### BACKGROUND OF THE INVENTION

1. Field of the Invention

The present invention relates to a lithium ion secondary battery.

2. Description of Related Art

From the viewpoints of the reduction of environmental load including the reduction of carbon dioxide emission and the decrease of the energy dependency on oil, the commercialization of a next-generation clean energy vehicle, such as a fuel-cell-powered vehicle, a plug-in hybrid electric vehicle or the like is desired. A lithium ion secondary battery is lightweight and compact, has a high energy density and a high output density, and therefore is increasingly expected in recent years as an electric power supply for such a next-generation clean energy vehicle. It goes without saying that higher performance of a battery is necessary in order to cope with the expectations and commercialize the battery and consequently the improvement of reliability and safety comes to be increasingly important.

Under such background, various technologies are disclosed in relation to the improvement of the reliability and safety of a battery caused by the improvement of battery materials such as positive and negative electrode materials, an electrolytic solution and a separator, or the improvement of a battery structure.

With regard to materials for a battery, the improvement of reliability and safety caused by the enhancement of the flame retardancy or nonflammability of an electrolytic solution or the adoption of a polymer solid electrolyte is proposed and research and development are actively made on the area. Such an electrolytic solution or an electrolyte is not yet applied to a battery mounted on a vehicle such as a next-generation clean energy vehicle however since the electrolytic solution or the electrolyte has a lower ionic conductivity than a currently used nonaqueous electrolytic solution and the decrease of output is concerned.

With regard to a material for a separator too, ingenuity is variously exercised in order to improve the performance and reliability of the battery. For example, separator technologies for forming a separator/electrode complex are proposed and technologies for improving the performance of the battery by the separator technologies are disclosed in Document 1 (Japanese Patent Laid-open No. 2007-157569) and Document 2 (Japanese Patent Laid-open No. 2007-157570).

An object of the present invention is to provide a lithium ion secondary battery that has high degrees of reliability and safety and is applicable to an environment-responsive vehicle such as a next-generation clean energy vehicle.

### SUMMARY OF THE INVENTION

A lithium ion secondary battery in the present invention comprises a positive electrode capable of lithium storage and release; a negative electrode capable of lithium storage and release; a nonaqueous electrolytic solution containing a lithium salt; and a separator interposed between the positive electrode and the negative electrode, wherein the separator is a porous polymer membrane, and a layer including lithium carbonate and a separator binder is formed on a surface of the separator facing the positive electrode.

### BRIEF DESCRIPTION OF THE DRAWINGS

FIG. 1 is a longitudinal sectional view illustrating a cylindrical lithium ion secondary battery according to an embodiment of the present invention.

FIG. 2 is a partial enlarged sectional view illustrating the cylindrical lithium ion secondary battery of FIG. 1.

### DETAILED DESCRIPTION OF THE PREFERRED EMBODIMENTS

We have found that the problems are solved and a lithium ion secondary battery that has high degrees of reliability and safety and is applicable to an environment-responsive vehicle such as a next-generation clean energy vehicle can be provided by using a separator of a structure in which a porous layer of lithium carbonate powder is formed on a porous polymer membrane.

The outline of the present invention is as follows.

A lithium ion secondary battery in the present invention comprises a positive electrode having a positive electrode collector both surfaces of which are coated with a positive electrode mixture containing a positive electrode active material, a conductive agent and a positive electrode binder; a negative electrode having a negative electrode collector both surfaces of which are coated with a negative electrode mixture containing a negative electrode active material and a negative electrode binder; a nonaqueous electrolytic solution containing a lithium salt; and a separator interposed between the positive electrode and the negative electrode, wherein the separator is a porous polymer membrane, and a layer including lithium carbonate and a separator binder is formed on a surface of the separator facing the positive electrode.

The present invention is characterized by a lithium ion secondary battery comprising a positive electrode to store and release lithium and a negative electrode to store and release lithium that are formed in the manner of interposing a nonaqueous electrolytic solution containing lithium salt and a separator, wherein the separator is a porous polymer membrane and a layer including lithium carbonate and a separator binder is formed on at least one surface of the polymer membrane. Here, the separator binder is a binder used on a surface of the separator.

The present invention is further characterized in that the layer including lithium carbonate and a binder is a porous layer and is formed on the surface facing the positive electrode.

The present invention is further characterized in that the binder is at least one of polyvinylidene fluoride and fluororubber and the separator is at least one of polypropylene and polyethylene.

Further, the present invention is characterized in that the nonaqueous electrolytic solution contains at least one of propylene carbonate, ethylene carbonate, butylene carbonate, vinylene carbonate, dimethyl carbonate, diethyl carbonate, methyl-ethyl carbonate, tetrahydrofuran and 1,2-diethoxyethane.

The present invention makes it possible to provide a lithium ion secondary battery having high degrees of reliability and safety, a large capacity, and a longer service life, and to provide the lithium ion secondary battery suitable for an environment-responsive vehicle such as a next-generation clean energy vehicle. In addition, the present invention makes it possible to widely provide a lithium ion secondary battery to the application field including electric power tools requiring a high output and a high capacity.

A lithium ion secondary battery according to the present invention is a lithium ion secondary battery having a positive electrode to store and release lithium and a negative electrode to store and release lithium that are formed in the manner of interposing a nonaqueous electrolytic solution containing lithium salt and a separator. The separator is a porous polymer membrane, and a layer including lithium carbonate powder and a binder is formed on at least one surface of the polymer membrane.

The safety of a lithium ion secondary battery is studied from various aspects such as battery component materials and a battery structure. With regard to the battery component materials, a separator for preventing a short circuit between a positive electrode and a negative electrode plays an important role and the safety of the battery largely depends on the material of the separator. As the separator of the lithium ion secondary battery, a porous polymer membrane comprising polyethylene, polypropylene or the like is used in many cases. The porous polymer membrane comprising polyethylene, polypropylene or the like however has a low heatproof temperature of a hundred and several tens of degrees Celsius and when the battery generates heat and raises temperature in an unusual case, a function of a short circuit prevention that is a primary important role of the separator is hindered because of thermal contraction. As a result, the positive electrode and the negative electrode cause the short circuit, heat generation is further accelerated and an accident such as a firing or the damage of the battery may occur in the worst case. In order to prevent such an accident, it is important to improve a heat resisting property of the separator and inhibit the short circuit. In an overcharge region in particular, the positive electrode material is destabilized and tends to generate heat. Consequently, it is preferable to improve the heat resisting property of the separator on the surface facing the positive electrode from the viewpoint of preventing the short circuit.

Although a ceramic material is supposed to be used as a thermal resistant material for a porous layer, a generally-known ceramic material such as alumina, magnesia or the like has a high density and it is concerned that original features such as lightness and compactness of the lithium ion secondary battery are hindered. Consequently, such a thermal resistant material is required to have a low density and not to adversely influence the lithium ion secondary battery.

As a result of variously studying the relationship between a separator having a thermal resistant porous layer and battery characteristics from the above viewpoint, it is found that a highly reliable and safe lithium ion secondary battery can be provided by using a separator having a structure in which a porous layer including lithium carbonate powder and a binder is formed on at least one surface of a porous polymer membrane.

As a porous polymer membrane used in the present invention, any material can be used as long as the material is generally used as the separator of the lithium ion secondary battery and there are no particular limitations. The porous layer can be formed by adding a binder and a solvent to lithium carbonate powder, thus preparing slurry for lithium carbonate coating, and coating a porous polymer membrane with a coating machine.

As the binder, a known binder, for example, polyvinylidene fluoride, fluororubber or the like may be used and the material is not particularly limited as long as the material does not adversely influence the lithium ion secondary battery. The solvent is used appropriately and an organic solvent such as N-methyl-2-pyrrolidone is preferably used for example. With regard to thickness of a porous layer, thick coating is not a problem as long as the thickness is in the range not hindering the gas permeability of a porous polymer membrane. A preferable coating thickness of a porous layer is several micrometers to a dozen micrometers from the viewpoint of operability and others. The mixing ratio of the lithium carbonate powder and the binder in slurry for lithium carbonate coating is not particularly limited but a preferable ratio of the lithium carbonate powder to the binder is 1 to 0.02-0.15 by weight. Further, there are some coating machines that have capability suitable for both-side coating and, if such a machine is used, the effects of the present invention is not changed at all even when the porous layers are formed on both surfaces of the porous polymer membrane in consideration of the operability and others.

A positive electrode used in the lithium ion secondary battery according to the present invention is formed by coating both surfaces of an aluminum foil (a positive electrode collector) with a positive electrode mixture containing a positive electrode active material, a conductive agent and a positive electrode binder, and thereafter applying drying and pressing. Here, the positive electrode binder is a binder used on a surface of the positive electrode collector.

As the positive electrode active material, a substance represented by the chemical formula LiMO₂ (M is at least one kind of transition metals), spinel-type lithium manganese oxide or the like can be used. A substance produced by replacing a part of Mn, Ni, Co or the like with one or more kinds of transition metals in a positive electrode active material of lithium manganese oxide, lithium nickel oxide, or lithium cobalt oxide may be used. It is also possible to use a substance produced by replacing a part of the transition metal with a metallic element such as Mg or Al.

As the conductive agent, a known conductive agent, such as carbonaceous conductive agent, for example, graphite, acetylene black, carbon black or carbon fiber or the like may be used and there are no particular limitations.

As the binder, a known binder, for example, polyvinylidene fluoride or fluororubber may be used and there are no particular limitations. A preferable binder in the present invention is polyvinylidene fluoride, for example.

With regard to the solvent, various known solvents can be used selectively in an appropriate manner and it is preferable to use an organic solvent such as N-methyl-2-pyrrolidone, for example. The mixing ratio of the positive electrode active material, the conductive agent and the binder in the positive electrode mixture is not particularly limited, but a preferable ratio is 1 to 0.05-0.20 to 0.02-0.10 by weight. That is to say, assuming that the positive electrode active material is 1 by weight, the conductive agent is 0.05-0.20 and the binder is 0.02-0.10.

A negative electrode used in the lithium ion secondary battery according to the present invention is formed by coating both surfaces of a copper foil (a negative electrode collector) with a negative electrode mixture containing a negative electrode active material and a negative electrode binder, and thereafter applying drying and pressing. A preferable material in the present invention is a carbonaceous material such as graphite or amorphous carbon. As the binder, a material similar to the material for a positive electrode is used, and there are no particular limitations. For example, a preferable material in the present invention is polyvinylidene fluoride. Here, the negative electrode binder is a binder used on a surface of the negative electrode collector.

A preferable solvent is an organic solvent such as N-methyl-2-pyrrolidone, for example.

The mixing ratio of the negative electrode active material and the binder in the negative electrode mixture is not particularly limited but a preferable ratio is 1 to 0.05-0.20 by weight. That is to say, assuming that the negative electrode active material is 1 by weight, the binder is 0.05-0.20.

As a nonaqueous electrolytic solution used in the lithium ion secondary battery according to the present invention, a known substance may be used and there are no particular limitations. As nonaqueous solvents, for example, propylene carbonate, ethylene carbonate, butylene carbonate, vinylene carbonate, dimethyl carbonate, diethyl carbonate, methyl-ethyl carbonate, tetrahydrofuran or 1, 2-diethoxyethane is used. It is possible to prepare a nonaqueous electrolytic solution by dissolving, for example, one or more kinds of lithium salt selected from a group of LiPF₆, LiBF₄, LiClO₄ and the like in one or more kinds of the solvents.

The shape of a lithium ion secondary battery includes a spirally-wound type, a stacked type and other types and there are no other particular limitations. The lithium ion secondary battery according to the present invention can be produced as follows, for example, if the shape is a cylindrical type.

Positive electrode slurry is obtained by adding and kneading a conductive agent such as graphite and a binder such as polyvinylidene fluoride dissolved in a solvent such as N-methyl-2-pyrrolidone to the positive electrode active material at the above ratio. Successively, both the surfaces of an aluminum foil as a collector (a positive electrode collector) are coated with the slurry. Thereafter drying and pressing are applied and thus a positive electrode is produced.

Successively negative electrode slurry is obtained by adding and kneading polyvinylidene fluoride or the like dissolved in N-methyl-2-pyrrolidone or the like as a binder to the negative electrode active material at the above ratio. Successively both the surfaces of a copper foil as a collector (a negative electrode collector) are coated with the slurry, thereafter drying and pressing are applied, and thus a negative electrode is produced. A nonaqueous electrolyte solution is produced by dissolving LiPF₆ or the like in a nonaqueous solvent such as ethylene carbonate. A porous polymer membrane separator having a lithium carbonate layer is interposed between the obtained positive and negative electrodes, they are wound spirally, and thereafter they are inserted into a battery can made by stainless steel or aluminum. After the lead pieces of the electrodes are connected to the battery can, the nonaqueous electrolyte solution is poured therein, the battery can is sealed, and thus a lithium ion secondary battery is obtained.

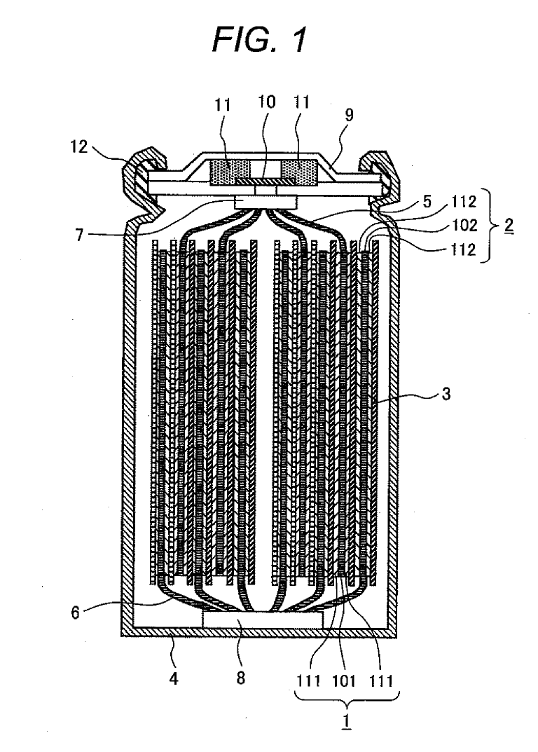

An example of a cylindrical lithium ion secondary battery to which the present invention is applied is shown in FIG. 1. The battery comprises a positive electrode 1, a negative electrode 2, a separator 3 disposed between the positive electrode 1 and the negative electrode 2, positive electrode collecting lead pieces 5 connecting the positive electrode 1 to a positive electrode collecting lead portion 7, negative electrode collecting lead pieces 6 connecting the negative electrode 2 to a negative electrode collecting lead portion 8, a battery can 4 to the bottom of which the negative electrode collecting lead portion 8 is connected, a battery lid 9 fixed by caulking to the open end of the battery can 4 through a gasket 12, positive electrode terminals 11 touching the bottom surface of the battery lid 9 and an open valve 10 interposed between the positive electrode terminals 11.

The positive electrode 1 is formed of a collector 101 (an aluminum foil) and positive electrode mixture layer 111 formed by coating both surfaces of the collector 101 with the aforementioned positive electrode mixture. The negative electrode 2 is formed of a collector 102 (a copper foil) and negative electrode mixture layer 112 formed by coating both surfaces of the collector 102 with the aforementioned negative electrode mixture.

The positive electrode 1 and the negative electrode 2 are spirally wound while the separator 3 is interposed in between and disposed in the interior of the battery can 4 as an electrode group. The space surrounded by the battery can 4 and the battery lid 9 is filled with an electrolytic solution (not shown in the figure).

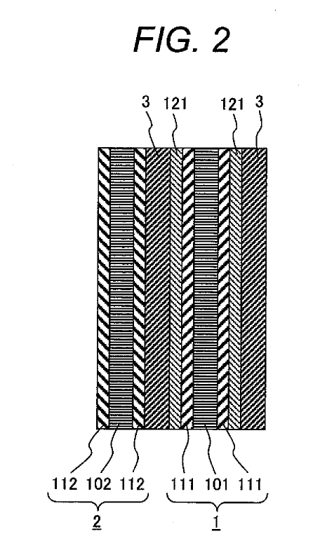

FIG. 2 is a partial enlarged sectional view illustrating a cylindrical lithium ion secondary battery according to the present invention.

A porous layer 121 including lithium carbonate and a binder is formed on a surface of the separator 3 facing the positive electrode 1.

The lithium ion secondary battery according to the present invention can be applied to the field of an environment-responsive vehicle such as a next-generation clean energy vehicle as stated earlier, the power supply of an electric power tool requiring a high load characteristic and a high output, and moreover portable equipment.

### EMBODIMENTS

The present invention is hereunder explained more specifically in reference to examples but the examples do not limit the scope of the present invention.

### Example 1

A positive electrode mixture is obtained by using LiCoO₂ as a positive electrode active material, and kneading the positive electrode active material, graphite as the conductive agent, and polyvinylidene fluoride as the binder at the weight ratio of 85:10:5 for 30 minutes with a kneading machine. Both surfaces of an aluminum foil having 30 μm in thickness as the collector are coated with the positive electrode mixture. Meanwhile, a graphite material is used as the negative electrode active material, polyvinylidene fluoride is used as the binder, and they are kneaded at the weight ratio of 90:10. Both surfaces of a copper foil having 20 μm in thickness are coated with the obtained negative electrode mixture. The obtained positive and negative electrodes are press-formed with a pressing machine and thereafter dried in vacuum for five hours at 150° C.

Successively slurry for lithium carbonate coating is obtained by kneading lithium carbonate powder and polyvinylidene fluoride as a binder at the weight ratio of 95:5 for 30 minutes. One surface of a porous polymer membrane (20 μm in thickness) formed of polyethylene (PE) is coated with the slurry and a separator having a porous layer 121 comprising lithium carbonate is obtained. Here, the thickness of the porous layer is 5 μm. The separator is dried in vacuum at 60° C., thereafter the positive electrode 1 and the negative electrode 2 are spirally wound while the separator 3 is interposed in between, and the obtained spirally-wound material is inserted into a battery can 4.

On this occasion, the porous layer of the separator is arranged so as to face the positive electrode. Obtained negative electrode collecting lead pieces 6 are collected to a nickel-made negative electrode collecting lead portion 8 and bonded by ultrasonic welding and the negative electrode collecting lead portion 8 is welded to a can bottom (FIG. 1). Meanwhile, the positive electrode collecting lead pieces 5 are bonded to an aluminum-made positive electrode collecting lead portion 7 by ultrasonic welding and thereafter the aluminum-made positive electrode collecting lead portion 7 is bonded to a can lid 9 by resistance welding. An electrolytic solution (A solute is LiPF₆. A solvent is a mixture of EC (ethylene carbonate) and MEC (methyl-ethyl, carbonate). EC: MEC=1:2) is poured, thereafter the battery lid 9 is sealed by caulking the battery can 4, and thereby a cylindrical battery is obtained.

In this case, a gasket 12 is inserted between an upper end and the battery lid 9 of the battery can 4 for insulating and sealing.

### Example 2

Except the separator portion, a positive electrode, a negative electrode and a battery are produced by the same method as Example 1. In this example, a separator having a lithium carbonate porous layer formed on one surface of a porous polymer membrane (20 μm in thickness) formed of polypropylene (PP) is used. The thickness of the lithium carbonate porous layer is 7 μm.

### Example 3

Except the separator portion, a positive electrode, a negative electrode and a battery are produced by the same method as Example 1. In this example, a separator having a lithium carbonate porous layer formed on one surface of a porous polymer membrane (25 μm in thickness) formed of polypropylene (PP)/polyethylene (PE)/polypropylene (PP) three layers is used. The thickness of the lithium carbonate porous layer is 6 μm.

### Example 4

Except the separator portion, a positive electrode, a negative electrode and a battery are produced by the same method as Example 1. In this example, a separator having lithium carbonate porous layers formed on both the surfaces of a porous polymer membrane (20 μm in thickness) formed of polyethylene (PE) is used. The total thickness of the lithium carbonate porous layers on both the surfaces is 11 μm.

### Comparative Example 1

Except the separator portion, a positive electrode, a negative electrode and a battery are produced by the same method as Example 1. In this comparative example, as the separator, a porous polymer membrane (20 μm in thickness) formed of polyethylene (PE) and not having a lithium carbonate porous layer is used.

### Comparative Example 2

Except the separator portion, a positive electrode, a negative electrode and a battery are produced by the same method as Example 1. In this comparative example, a battery is produced by using a porous polymer membrane (20 μm in thickness) formed of polypropylene (PP) and not having a lithium carbonate porous layer as the separator.

### Comparative Example 3

The same positive electrode, negative electrode, separator and battery as Example 1 are produced. Here, in this comparative example, the lithium carbonate porous layer is formed only on a surface of the separator facing the negative electrode.

Ten batteries are produced in each of Examples 1 to 4 and Comparative examples 1 to 3, respectively. Each of the batteries is charged and discharged under the conditions of an end-of-charge voltage of 4.2 V, an end-of-discharge voltage of 3.0 V, and a charge-discharge rate of 1 C (one hour rate) and the discharge capacity is confirmed. An overcharge test is carried out under the test condition where two and a half times electric quantity of the discharge capacity is charged to a discharged battery. The results obtained by examining the behavior of the batteries at the time are shown in Table 1.

TABLE 1

| | Separator | Test result |
|---|---|---|
| Example 1 | PE (porous layer on one surface, | No smoking |
| | positive electrode side) | |
| Example 2 | PP (porous layer on one surface, | No smoking |
| | positive electrode side) | |
| Example 3 | PE/PP/PE (porous layer on one | No smoking |
| | surface, positive electrode | |
| | side) | |
| Example 4 | PE (porous layers on both | No smoking |
| | surfaces, positive electrode | |
| | side) | |
| Comparative | PE | 10 batteries |
| example 1 | | (Smoking) |
| Comparative | PP | 10 batteries |
| example 2 | | (Smoking) |
| Comparative | PE (porous layer on one surface, | 7 batteries |
| example 3 | negative electrode side) | (Smoking) |

In any of the cases of Examples 1 to 4, a smoking phenomenon caused by the overcharge of the battery is not observed. In the cases of the batteries of Comparative examples 1 to 3 in contrast, most of the batteries cause smoking.

What is claimed is:

1. A lithium ion secondary battery comprising:
a positive electrode capable of lithium storage and release;
a negative electrode capable of lithium storage and release;
a nonaqueous electrolytic solution containing a lithium salt; and
a separator interposed between the positive electrode and the negative electrode,
wherein the separator is a porous polymer membrane, and a layer including lithium carbonate and a separator binder is formed on a surface of the separator facing the positive electrode.

2. A lithium ion secondary battery according to claim 1, wherein the layer is a porous layer.

3. A lithium ion secondary battery according to claim 1, wherein the separator binder is formed of at least one of polyvinylidene fluoride and fluororubber.
